(19) United States
(12) Patent Application Publication
(10) Pub. No.: US 2026/0154938 A1
(43) Pub. Date: Jun. 4, 2026

(54) HUMAN PRESENCE DETECTION (HPD) CONTROL SYSTEMS

(71) Applicant: QUALCOMM Incorporated, San Diego, CA (US)

(72) Inventors: Yi-Han LIAO, Taipei City (TW); Jiankai WANG, New Taipei City (TW); Wei-Te CHANG, Taipei City (TW); Wei-Chih LIU, Taipei City (TW); Chia-Yuan TENG, San Diego, CA (US); Wen-Chun FENG, New Taipei City (TW)

(21) Appl. No.: 18/969,058

(22) Filed: Dec. 4, 2024

(51) Int. Cl. G06V 10/75; G06V 10/25; G06V 10/82; G06V 40/16

(52) U.S. Cl. CPC G06V 10/751; G06V 10/25; G06V 10/82; G06V 40/161; G06V 40/172

(57) ABSTRACT

Techniques and systems are provided for presence detection. For instance, a process can include detecting a portion of a person in an image to generate a region of interest (ROI) around the detected portion of the person and confidence information; obtaining a fold angle of a device, wherein the fold angle indicates an angle between two moveable portions of the device; adjusting, based on the fold angle, at least one of a confidence threshold or a size of the ROI; and determining the detection of the portion of the person was successful based on a comparison of at least one of the confidence information with the confidence threshold or the size of the ROI with a threshold ROI size.

### FIELD

This application is related to processing one or more images for detecting a person in the images. For example, aspects of the application relate to systems and techniques providing control systems for human presence detection (HPD).

### BACKGROUND

People may interact with various devices daily. These devices may include a variety of sensors, such as image sensors (e.g., cameras). To facilitate interactions with people, devices may use the sensors to detect a presence of a person and react to that presence, such as by activating a screen, exiting a reduce power consumption state, or the like. As an example, human presence detection (HPD) can detect whether a person is within view of a sensor, such as an image sensor, and perform an action, such as activating a screen on a device, such as a laptop, desktop, smartphone, etc. In some cases, HPD detection may detect persons by detecting faces in captured or continuous preview images. However, people may not approach a device in a way that is always within view of a sensor. For example, a person may approach a device from a side and a captured image may just include a portion of a face. Existing HPD systems may have difficulties dealing with images of a portion of the face. Therefore, techniques to improve HPD control systems may be useful.

### SUMMARY

Systems and techniques are described herein for detecting people. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for an apparatus for presence detection is provided. The apparatus includes a memory comprising instructions and a processor coupled to the memory. The processor is configured to: detect a portion of a person in an image to generate a region of interest (ROI) around the detected portion of the person and confidence information; obtain a fold angle of the apparatus, wherein the fold angle indicates an angle between two moveable portions of the apparatus; adjust, based on the fold angle, at least one of a confidence threshold or a size of the ROI; and determine the detection of the portion of the person was successful based on a comparison of at least one of the confidence information with the confidence threshold or the size of the ROI with a threshold ROI size.

As another example, a method for presence detection is provided. The method includes: detecting a portion of a person in an image to generate a region of interest (ROI) around the detected portion of the person and confidence information; obtaining a fold angle of a device, wherein the fold angle indicates an angle between two moveable portions of the device; adjusting, based on the fold angle, at least one of a confidence threshold or a size of the ROI; and determining the detection of the portion of the person was successful based on a comparison of at least one of the confidence information with the confidence threshold or the size of the ROI with a threshold ROI size.

In another example, A non-transitory computer-readable medium having stored thereon instructions is provided. The instructions, when executed by at least one processor, cause the at least one processor to: detect a portion of a person in an image to generate a region of interest (ROI) around the detected portion of the person and confidence information; obtain a fold angle of the apparatus, wherein the fold angle indicates an angle between two moveable portions of the apparatus; adjust, based on the fold angle, at least one of a confidence threshold or a size of the ROI; and determine the detection of the portion of the person was successful based on a comparison of at least one of the confidence information with the confidence threshold or the size of the ROI with a threshold ROI size.

As another example, an apparatus for presence detection is provided. The apparatus includes: means for detecting a portion of a person in an image to generate a region of interest (ROI) around the detected portion of the person and confidence information; means for obtaining a fold angle of a device, wherein the fold angle indicates an angle between two moveable portions of the device; means for adjusting, based on the fold angle, at least one of a confidence threshold or a size of the ROI; and means for determining the detection of the portion of the person was successful based on a comparison of at least one of the confidence information with the confidence threshold or the size of the ROI with a threshold ROI size.

In some aspects, the apparatus can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the apparatus further includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit data or information over a transmission medium to at least one device. In some aspects, the processor includes a central processing unit (CPU), a graphics processing unit (GPU), a neural processing unit (NPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2A is a block diagram illustrating an HPD controller, in accordance with aspects of the present disclosure.

FIG. 2B illustrates a partial face, in accordance with aspects of the present disclosure.

FIG. 3 is a block diagram illustrating an enhanced HPD controller, in accordance with aspects of the present disclosure.

FIG. 4 is a flow diagram illustrating an overview of a technique for enhanced HPD control, in accordance with aspects of the present disclosure.

FIG. 5 is a flow diagram illustrating operations of a partial face engine, in accordance with aspects of the present disclosure.

FIG. 6 illustrates confidence thresholds in a field of view of an image, in accordance with aspects of the present disclosure.

FIG. 7 illustrates a technique for determining a fold angle of a device based on images, in accordance with aspects of the present disclosure.

FIG. 8 illustrates calculation of a face angle based on a ration between distances between facial landmarks, in accordance with some aspects.

FIG. 9 is an illustrative example of a neural network, in accordance with aspects of the present disclosure.

FIG. 10 is an illustrative example of a convolutional neural network (CNN), in accordance with aspects of the present disclosure

FIG. 11 is a flow diagram illustrating a process for presence detection, in accordance with aspects of the present disclosure

FIG. 12 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

A camera (e.g., image capture device) is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

People may interact often with devices. In some cases, human presence detection (HPD) may be used to make interacting with a device easier. HPD may allow a device to detect a nearby person, such as a person approaching to interact with the device, and take certain actions, such as waking up a screen of a device. In some cases, HPD may detect a nearby person by detecting a face of person using a face detector. The face detector may use a camera to generate images of person and attempt to detect faces using the images from the camera. In some cases, the device may have moveable portions. These moveable portions may allow the device to be folded for example to reduce a size/bulk of a device or to allow an interface of the device, such as a screen, to be adjusted, such as in a laptop, convertible device, foldable smartphone, etc. The camera may be integrated on a same plane as a screen on the device, such as a camera positioned above/below a screen. In many cases, the face detector may attempt to detect an entire face and when only part of a face is visible, the face detector may fail.

Systems, apparatuses, methods (also referred to as processes), and computer-readable media (collectively referred to herein as “systems and techniques”) are described herein for performing face detection for devices. For example, a device may attempt to detect a partial face of a person for HPD to activate/deactivate a screen of the device when the person approaches/leaves the device. The device may attempt to detect a partial face by detecting a portion of the person in a received image. The portion of the person may be a part of the face (e.g., a partial face). In some cases, machine learning (ML) based techniques may be used to detect the partial face. As a part of detecting the partial face, an region of interest around the detected person and confidence information for the detection may be generated. The confidence information may be a confidence score. Detecting the partial face may be performed after an attempt to detect a full face in the image has failed.

Based on the detecting, a fold type and/or fold angle of the device may be determined. The fold angle may be an angle between two moveable portions of the device, such as a keyboard portion and a screen portion. The fold angle may be used to adjust the confidence information and/or the size of the ROI to account for how the device may be folded. For example, the detection of the portion of the person may not be considered a successful if a size of the ROI does not meet a threshold ROI size, or if the confidence score does not meet a confidence threshold. In some cases, the confidence score and/or ROI size may be adjusted based on the fold angle of the device. For example, a confidence score may be adjusted upwards or downwards based on the fold angle of the device. Similarly, the ROI size may be adjusted upwards or downwards based on the fold angle of the device. If the ROI size and/or confidence score meets a ROI size threshold and/or confidence threshold, then the detection of the portion of the person may be considered successful.

In some cases, the fold angle may be determined using a fold angle sensor of the device. The fold angle sensor may directly sense the fold angle using, for example, a hall effect sensor. In other cases, the fold angle may be determined based on the image. For example, the fold angle may be determined based on a ratio between distances of facial landmarks in the received image.

Various aspects of the application will be described with respect to the figures.

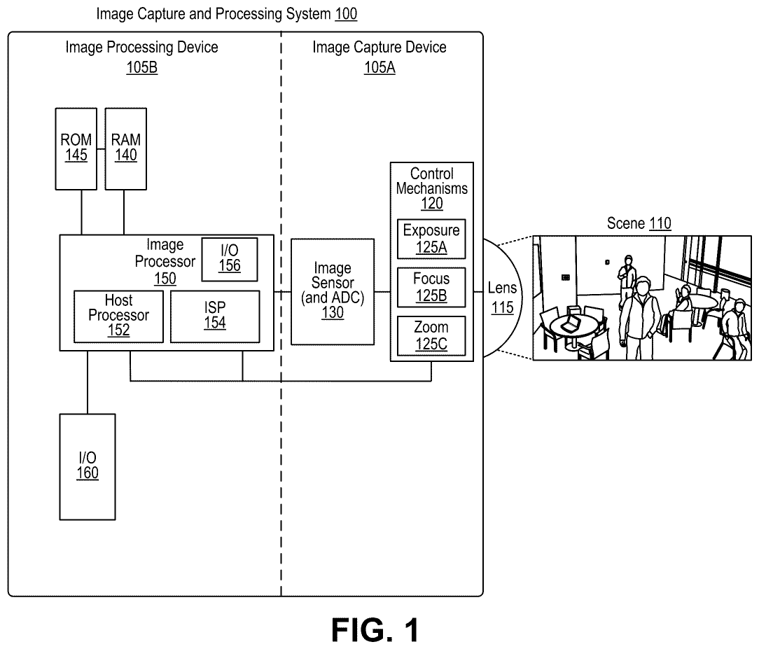

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

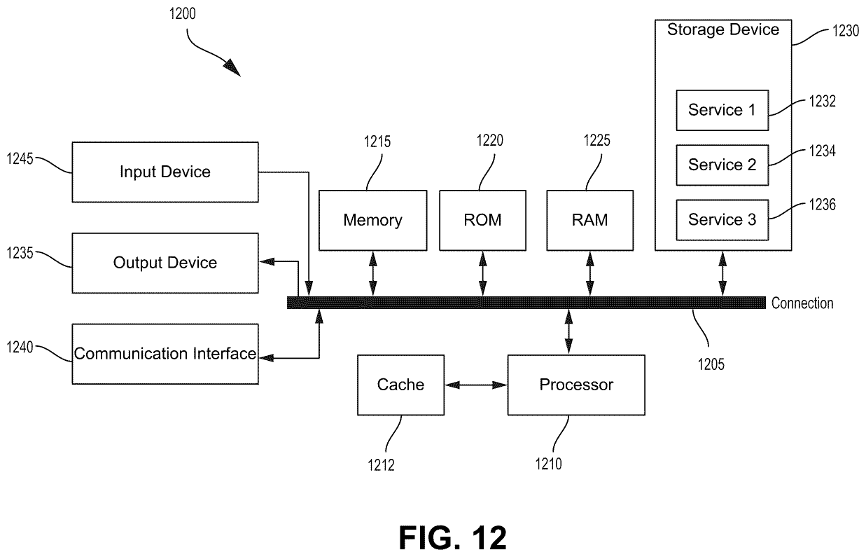

The image processor 150 may include one or more processors, such as one or more image signal processors (ISPs) (including ISP 154), one or more host processors (including host processor 152), and/or one or more of any other type of processor 1210 discussed with respect to the computing system 1200 of FIG. 12. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1235, any other input devices 1245, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

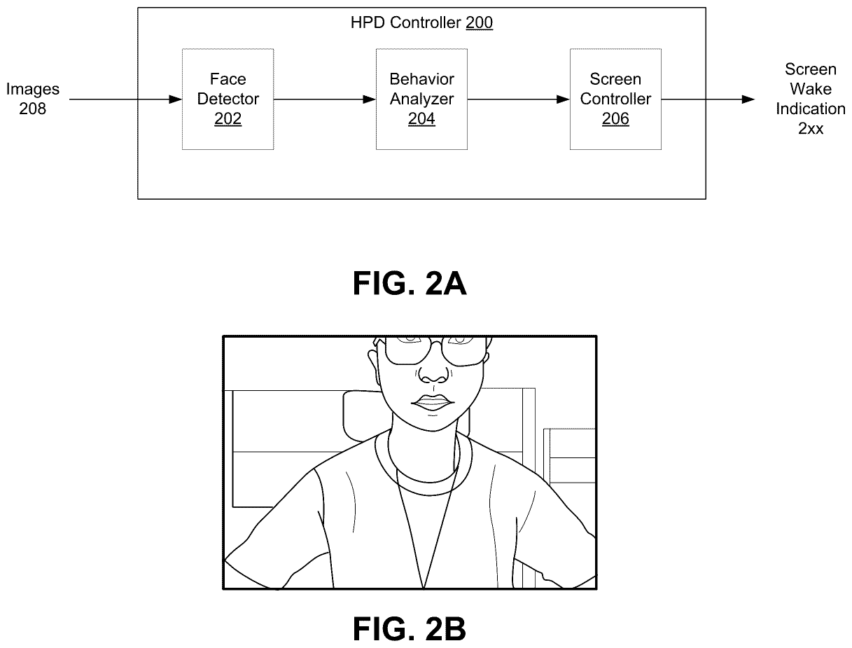

FIG. 2A is a block diagram illustrating an HPD controller 200, in accordance with aspects of the present disclosure. The HPD controller 200 includes a face detector 202, a behavior analyzer 204, and a screen controller 206. In some cases, the face detector may receive a stream of images 208, for example, from a camera (e.g., image sensor). In some cases, the camera may be a color (e.g., RGB) camera. in other cases, camera may be a monochrome camera, or camera that senses another wavelength, such as an infrared camera, near-infrared camera, etc.

The face detector 202 may receive the images 208 and the face detector 202 may attempt to detect a face in the images 208. For example, the face detector 202 may include one or more machine learning (ML) models for detecting faces. Examples of face detection ML models may include neural network (NN) based detectors, deep learning (DL) based detectors, and the like, examples of which may include single shot scale invariant face detector, multi-task cascade convolutional neural network face detector, Haar cascade face detector, and the like. In some cases, the face detector 202 may also indicate a location of the face in an image, such by providing coordinates for a region of interest (ROI) (e.g., bounding box) for where the detected face is located in an image. The face detector 202 may pass the indication that a face (e.g., ROI coordinates and/or size of ROI) was detected to the behavior analyzer 204. In some cases, the face detector 202 may also detect (e.g., extract) features from a face visible in the images 208 and compare detected features to expected features for a face in general or for a specific face.

The behavior analyzer 204 may analyze the detected face to determine what actions may be taken. The behavior analyzer 204 may take into consideration a current state of the device along with the behavior of the person (e.g., detected face). For example, if the face detector 202 indicates that a person has been detected and a screen of a device is already on, then the behavior analyzer 204 may take no action. However, if the face detector 202 indicates that a person has been detected and the screen of the device is on, then the behavior analyzer 204 may indicate (e.g., transmit an indication) to the screen controller 206 to turn off the screen of the device. Similarly, if the face detector 202 indicates that a person has been detected and the screen of the device is off, then the behavior analyzer 204 may indicate (e.g., transmit an indication) to the screen controller 206 to turn on the screen of the device.

In some cases, the behavior analyzer 204 may analyze the behavior of the person (e.g., detected face) over a number of frames to determine what actions may be taken. For example, the behavior analyzer 204 may check a size (e.g., dimensions) of the ROI over a number of frames. If the size of the ROI increases over the number of frames, then the person may be approaching the device. Conversely, if the size of the ROI decreases over the number of frames, then the person may be leaving the device. If the device screen is off and a person is leaving the device, the behavior analyzer 204 may take no action. If the device screen is off and a person is approaching the device, the behavior analyzer 204 may indicate to the screen controller 206 to turn on the screen of the device. If the device screen is on and a and a person is leaving the device, the behavior analyzer 204 may indicate to the screen controller 206 to turn off the screen of the device.

In some cases, the screen controller 206 may indicate to another component of the device, such as a screen of the device, to perform some action, such as to turn off or turn of the screen of the device.

In some cases, the face detector 202 may have difficulties detecting a face in certain conditions. For example, as shown if FIG. 2B, the face detector 202 of FIG. 2A may have difficulties detecting a face when only a portion of the face (e.g., less than substantially all of a face) is visible in a field of view of the camera. In some cases, the face detector 202 may also have difficulties detecting a face in challenging light conditions (e.g., insufficient lighting, backlighting, etc.), when lens distortion is present, unstable detection is present (e.g., due to movement, insufficient information/feature points detected, etc.), and the like. An inability to detect partial faces may be problematic as not everyone may approach a device directly. Rather, some people may approach a device from a side, from above, from below, etc. Additionally, a person may not always face the device such that their face is within a field of view of a sensor of the device. In such cases, the person's face may only be partially visible and the device may not perform some action, such as activating a screen of the device, as well as (e.g., as soon as) if their face was completely within the field of view of the sensor. In some cases, an HPD controller 200 of FIG. 2A may be enhanced to better detect partial faces in the field of view of a sensor.

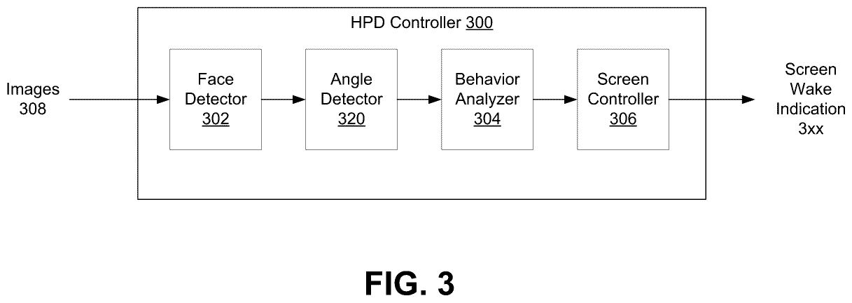

FIG. 3 is a block diagram illustrating an enhanced HPD controller 300, in accordance with aspects of the present disclosure. The enhanced HPD controller 300 may include a face detector 302 that supports different types of faces, an angle detector 320, a behavior analyzer 304, and screen controller 306. In some cases, the behavior analyzer 304 and screen controller 306 may be substantially similar to behavior analyzer 204 of FIG. 2A and screen controller 206 of FIG. 2A, respectively. For the enhanced HPD controller 300, the face detector 302 may be configured to detect partial faces, and the angle detector 320 included to aid partial face detection for device which include a screen that may be moved, such as a laptop, foldable smartphone, etc., for example, by adjusting an ROI size based on a fold angle of the screen.

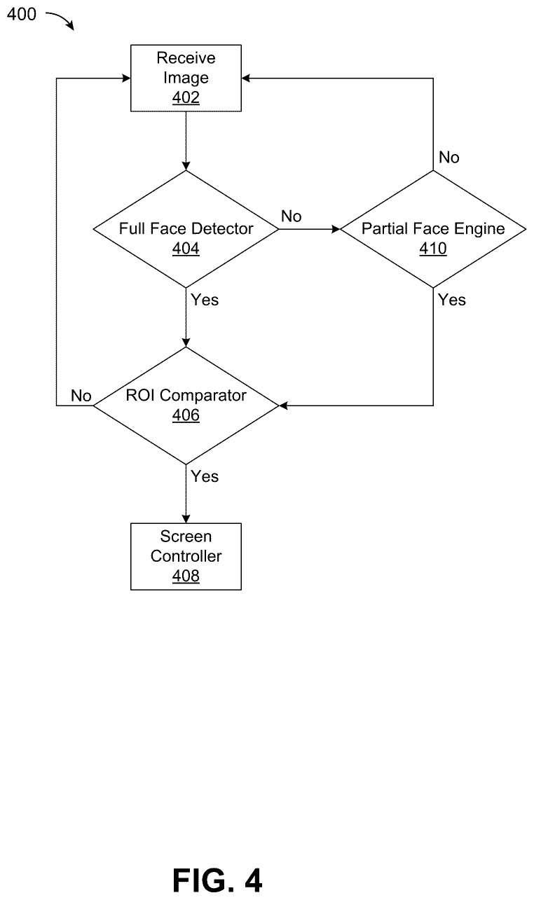

FIG. 4 is a flow diagram illustrating an overview of a technique for enhanced HPD control 400, in accordance with aspects of the present disclosure. In FIG. 4, an image may be received 402, for example, from a camera. In some cases, the camera may be an always on camera. The received image 402 may be a preview image from the always on camera. In some cases, a preview image may be a captured image from a camera that is not for storage in a storage device (e.g., storage device 1230 of FIG. 12. For example, a preview image may be captured for display in a view finder screen (e.g., to assist a user to capture an image), processed to extract information about an environment, etc. In some cases, the preview image may be received, for example by an HPD controller (e.g., HPD controller 300 of FIG. 3), for processing to determine whether a person is present.

The received image 402 may be analyzed by a full face detector 404 to determine whether the image includes a full face. In some cases, the full face detector 404 may be substantially similar to that described above with respect to the face detector 202 of FIG. 2A. For example, the full face detector 404 may use a ML model for detecting full faces. If a full face is detected, the full face detector 404 may indicate that a face has been detected by transmitting ROI coordinates and/or a size of an ROI around the face to an ROI comparator 406. The ROI comparator 406 may compare a size of the ROI around the detected face to a threshold ROI size.

Faces that are further away from the device may appear smaller than faces which are closer to the device. Additionally, it may not be useful for the device to perform an action, such as activating a screen of the device, when a user is too far away to possibly interact with the device, so a threshold ROI size may be set. When the user approaches the device from further away, the ROI corresponding to a detected face of the user may get larger. Once the user is within a certain distance, their face may appear larger (e.g., have a determined ROI size larger) than the threshold ROI size. When the determined ROI size is larger than the threshold ROI size, the ROI comparator 406 may indicate to a screen controller 408 to activate the screen. In some cases, screen controller 408 may be substantially similar to screen controller 206 of FIG. 2A and screen controller 306 of FIG. 3. In cases where the determined ROI size is smaller than the threshold ROI size, the ROI comparator 406 may not indicate to the screen controller 408 and a next received image 402 may be processed.

In some cases, the full face detector 404 may not detect a face in the received image 402. For example, the full face detector 404 may not be able to detect partial faces in the received images. In such cases, the received image 402 may be passed to the partial face engine 410. In some cases, the received image 402 may be input both the full face detector 404 and partial face engine 410 in parallel and the full face detector 404 and partial face engine 410 may operate concurrently to detect faces. The partial face engine 410 may attempt to detect a partial face in the received image 402.

In some cases, the partial face engine 410 may include a ML model trained to detect partial faces instead of, or in conjunction with, full faces. In some cases, the partial face engine 410 may obtain a fold angle of the device and compensate for the fold angle of the device to help detect faces. For example, the partial face engine 410 may adjust confidence thresholds or ROI sizes based on the fold angle of the device. As a more specific example, the partial face engine 410 may detect a partial face and then may adjust a confidence threshold and/or adjust a size of the ROI for the detected partial face. The confidence threshold may be adjusted by raising or lowering the confidence threshold based on the fold angle. In some cases, multiple confidence threshold may be used for different regions of the screen and the confidence thresholds for different regions of the screen may be adjusted. In some cases, if the partial face engine 410 detects a face in the received image 502, the partial face engine 410 may pass the ROI size (which may be an adjusted ROI size) to the ROI comparator 406 for comparison to a threshold ROI size. The ROI size from the partial face engine 410 may be compared by the ROI comparator 406 in a manner substantially similar to that described above with respect to the ROI from the full face detector 404. If the partial face engine 410 does not detect a face in the received image 402, a next received image 402 may be processed.

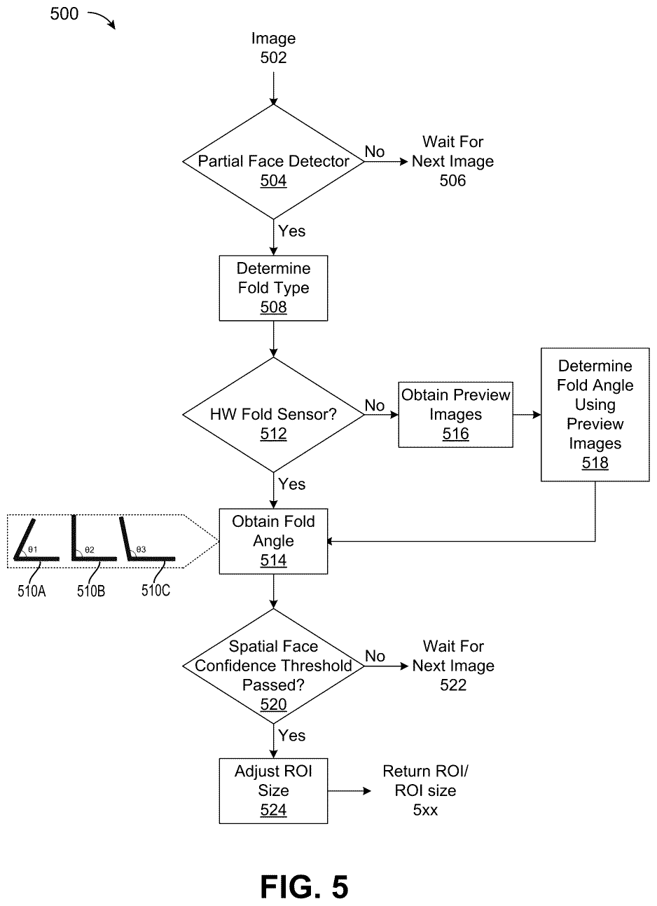

FIG. 5 is a flow diagram illustrating operations of a partial face engine 500, in accordance with aspects of the present disclosure. In some cases, partial face engine 410 of FIG. 4 may perform the operations of partial face engine 500. In FIG. 5, an image 502 may be received by a partial face detector 504. The image 502 may be substantially similar to received image 402 of FIG. 4. The partial face detector 504 may be a ML model trained to detect partial faces instead of, or in conjunction with, full faces. The partial face detector 504 may include one or more machine learning (ML) models for detecting partial faces and/or full faces, such as neural network (NN) based detectors, deep learning (DL) based detectors, and the like, examples of which may include single shot scale invariant face detector, multi-task cascade convolutional neural network face detector, Haar cascade face detector, and the like. In cases where the partial face detector 504 does not detect a face in the image 502, the partial face engine 500 may stop and wait for a next image 506. As an example, the ML model may analyze the image to detect feature points corresponding to a person in the image 502. These feature points may be analyzed to determine if the feature points form facial landmarks, such as a tip of the nose, corners of the mouth, eyes, etc. Based on how well a pattern of feature points and facial landmarks align with expected patterns of feature points and facial landmarks for faces, the ML model may determine whether a person has been detected. In some cases, the ML model may also determine confidence information indicating a likelihood that the face is present based on how well the pattern of feature points and facial landmarks align with expected patterns of feature points and facial landmarks.

If the partial face detector 504 does detect a face in the image 502, the partial face detector 504 may output an indication of a detected face. For example, the partial face detector 504 may output ROI coordinates and/or a size of ROI along with confidence information (e.g., confidence score). The confidence information may indicate a likelihood that the face is present in the image 502. In some cases, if a face is detected by the partial face detector 504, the partial face engine 500 may determine a fold type 508. In some cases, a fold type may be based on a fold angle. The fold angle may be an angle between two moveable portions of a device.

Using a laptop as an example, a keyboard portion of the laptop may be attached to a screen portion of the laptop via a hinge and when opened there may be about ˜60 degree to ˜170 degree angle between the keyboard portion and the display portion. The angle between the screen portion of the laptop and the keyboard portion may be the fold angle (e.g., example fold angles 510A, 510B, and 510C, collectively, fold angles 510). In some cases, different fold types may be based on ranges of fold angles. For example, fold angles below approximately 80 degrees (e.g., fold angle 510A) may be a first fold type (e.g., acute fold type), fold angles above approximately 80 degrees and less than approximately 100 degrees (e.g., fold angle 510B) may be a second fold type (e.g., right fold type), and fold angles larger than approximately 100 degrees (e.g., fold angles 510C) may be a third fold type (e.g., obtuse fold type).

To determine the fold angle, a check for a hardware fold sensor 512 (e.g., lid position sensor) may be performed. If the device includes a fold sensor, the fold angle of the device may be obtained 514 from the fold sensor. In some cases, the fold sensor may be a hall effect sensor (or other similar sensor for detecting the fold angle) positioned, for example, on a hinge of the device. In cases where the device does not include a fold sensor, the fold angle may be determined 518 based on a set of obtained images 516 (e.g., preview images). In some cases, as discussed further below, the fold angle may be determined (e.g., predicted) based on how facial landmarks in images of the set of images are distributed.

Based on the obtained fold angle 514 (e.g., obtained via the fold sensor or based on the set of obtained images 516), the confidence information for a detected face may be compared to confidence threshold 520. As detailed below, the confidence threshold may be adjusted based on the fold type and/or fold angle. If the confidence information does not pass the confidence threshold, then the partial face engine 500 may stop and wait for a next image 522.

If the confidence information passes the confidence threshold, then the ROI size may be adjusted 524 based on the fold type and/or fold angle and the ROI information (e.g., size coordinates, etc.) may be returned 526 (e.g., output), for example, to an ROI comparator (e.g., ROI comparator 406 of FIG. 4) for further processing. In some cases, the ROI size may be provided by the partial face detector 504. In some cases, when the fold type is the right fold type (e.g., fold angle 80 degrees to 100 degrees), the ROI size may not be adjusted. For example, the ROI size may correspond to how far a person may be from the device such that a smaller ROI size, the further a person may be from the device, while a larger ROI size may indicate that the person is closer to the device. In some cases, a ROI comparator (e.g., ROI comparator 406) may compare the ROI size with a threshold ROI size to determine whether a detected person is sufficiently close for an action to be taken by the device, such as to turn on a screen of the device. For example, the fold angle of the device may cause a user to appear smaller (and hence further away) or larger (and hence closer) as compared to when the device has a right fold angle. As another example, feature points closer to a top of the screen may be more likely to be missing for an acute fold type and features points closer to a bottom of the screen may be more likely to be missing for an obtuse fold type. To allow the device to more consistently respond (e.g., take an action) to the presence of the user based on the distance the user is from the device, it may be useful to adjust the ROI size prior to the comparison by the ROI comparator to help compensate for a fold angle of the device.

For example, where the fold type is an acute fold type (e.g., fold angle is below 80 degrees), the ROI size may be increased, as a camera of the device may be positioned closer to the user, making the user appear larger in the field of view of the camera, as compared to when the fold type is a right fold type. Increasing the ROI size may help compensate, for example, for distortion (e.g., wide-angle lens distortion, fish-eye distortion, etc.) which may cause an object (e.g., a person) to appear smaller when the object is closer to an edge of the field of view. As another example, where the fold type is an obtuse fold type (e.g., fold angle above 100 degrees), the ROI size may be decreased, as a camera of the device may be positioned further from the user, making the user appear smaller in the field of view of the camera. In some cases, the amount the ROI size may be increased or decreased may be based on the specific obtained fold angle 514. In some cases, the amount the ROI size may be adjusted for a specific obtained fold angle may be predetermined and may be provided, for example, using a mapping. After the ROI size is adjusted based on the fold type, the ROI information (e.g., ROI size and/or ROI coordinates) may be returned 526, for example, to the ROI comparator (e.g., ROI comparator 406 of FIG. 4).

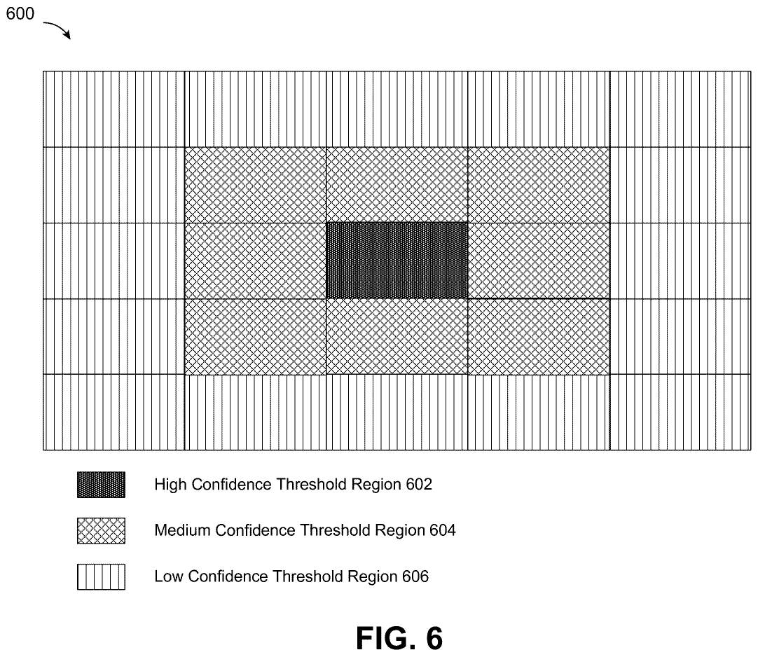

FIG. 6 illustrates confidence thresholds in a field of view of an image 600, in accordance with aspects of the present disclosure. In some cases, multiple confidence thresholds may be used based on where a person is detected. For example, where a person is detected near a center of image 600, an ROI corresponding to the person may have a location within a high confidence threshold region 602. In the high confidence threshold region 602, the confidence threshold for the confidence information of the ROI may be set to a highest level out of all of the confidence thresholds for the image 600. Thus, detected ROIs within the high confidence threshold region 602 may be associated with a higher level of confidence to be accepted as a successful detection.

In some cases, a low confidence threshold region 606 may be defined along an outer edge of the image 600. In the low confidence threshold region 606, the confidence threshold of the confidence information of the ROI may be set at a lower level out of all of the confidence thresholds for the image 600. Detected ROIs within the low confidence threshold region 606 may be associated with a lower level of confidence to be accepted as a successful detection.

Similarly, a medium confidence threshold region 604 may be defined between the low confidence threshold region 606 and the high confidence threshold region 602. In the medium confidence threshold region 604, the confidence threshold of the confidence information of the ROI may be set above the confidence threshold associated with the low confidence threshold region 606 and below the confidence threshold associated with the high confidence threshold region 602. Detected ROIs within the medium confidence threshold region 646 may be associated with a lower level of confidence as compared to the high confidence threshold region 602 and a higher level of confidence as compared to the low confidence threshold region 606.

In some cases, the confidence threshold regions may be adjusted based on the fold type and/or fold angle. For example, where the device is folded at an acute angle, faces may appear more along an upper edge of the image 600. In such cases, the high confidence threshold region 602 and/or the medium confidence threshold region 604 may be shifted towards the upper edge of the image 600. In some cases, a size of the high confidence threshold and/or medium confidence threshold regions may be enlarged, for example, where fold type is an acute fold type and the person may appear larger in the image 600. Similarly, a size of the high confidence threshold and/or medium confidence threshold regions may be reduced, for example, where fold type is an obtuse fold type and the person may appear smaller in the image 600. The confidence thresholds may also be adjusted by raising or reducing the confidence thresholds (e.g., the low confidence threshold, medium confidence threshold, and high confidence threshold) individually or as a group. In some cases, the amount the confidence thresholds may be adjusted for a specific obtained fold angle may be predetermined and may be provided, for example, using a mapping.

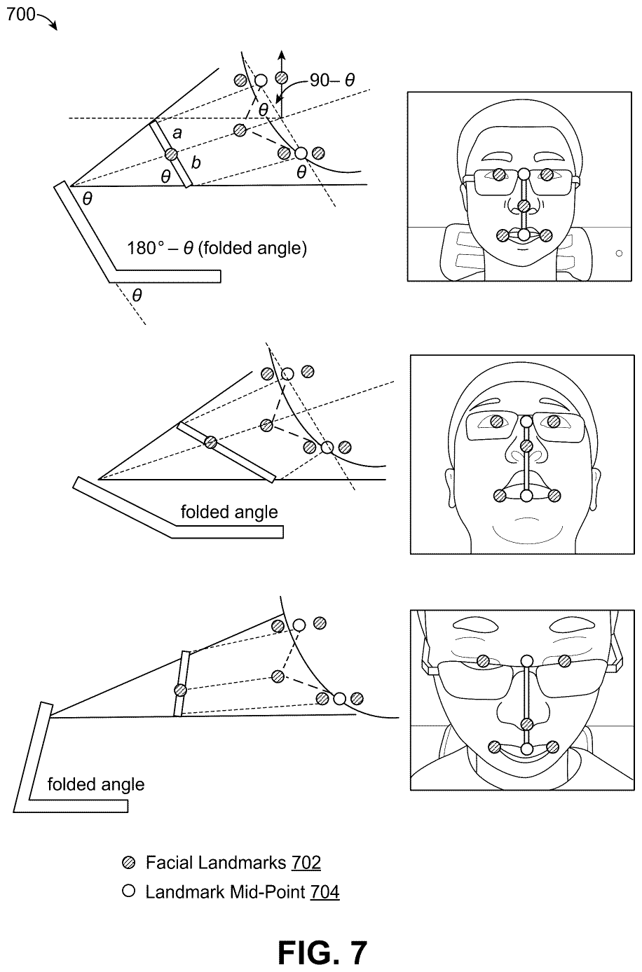

FIG. 7 illustrates a technique for determining a fold angle of a device based on images 700, in accordance with aspects of the present disclosure. In some cases, it may be assumed that a person approaching the device to use the device will look at the screen of the device. Based on an assumption that a person looking at the screen of the device will more or less directly look at the screen, a plane of the face may be parallel to the screen. In some cases, a camera may also be parallel to the screen. The angle of the face may then be determined and the angle of the face may be used as the angle of the screen. The fold angle may then be determined based on the angle of the screen.

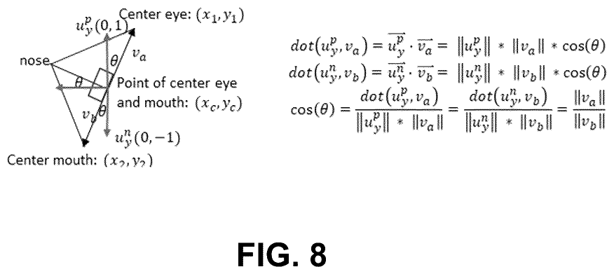

In some cases, an angle of the face and fold angle may be determined based on facial landmarks 702, such as a center of an eye, corners of the mouth, tip of the nose, etc. In some cases, a location of the facial landmarks 702 may be obtained, for example, from a partial face detector 504. In some cases, facial landmarks 702 may be detected, for example, using a ML backbone or set of feature detectors. In some cases, a mid-point 704 may be found between certain facial landmarks 702, such as a mid-point between the eyes and a mid-point between the corners of the mouth. A first distance a may then be determined between the mid-point between the eyes and the tip of the nose. A second distance b may then be determined between the mid-point between the corners of the mouth (e.g., center of the mouth) and the tip of the nose. A ratio between the first distance a and the second distance b may be determined and this ratio may be used to estimate an angle of the face θ. In some cases, ratios between the first distance a and the second distance b may be mapped to estimated angles of the face, as shown in FIG. 8.

In some cases, one or more ML techniques (e.g., a neural network or other ML technique) may be used to estimate the angle of the face θ based on the ratio between the first distance a and the second distance b. An estimated fold angle for a device, such as a laptop may be determined by subtracting the angle of the face θ from 180 (e.g., 180−θ). In some cases, multiple images may be used over a period of time to obtain a stable and/or consistent fold angle. Capturing multiple images from different angles of the face may be used to help determine the facial landmarks and angles. For example, a temporal filter or state machine may be used to obtain a consistent fold angle. In some cases, a temporal filter may help stabilize the face and reduce inaccurate predications of the facial landmarks. A state machine may be used to make more consistent predictions to reduce an influence of, for example, environmental changes.

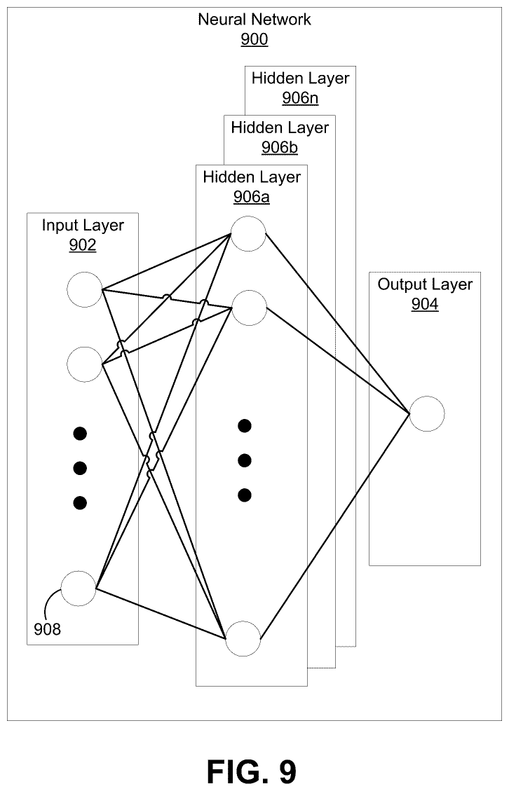

FIG. 9 is an illustrative example of a neural network 900 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, a full face detector 404 of FIG. 4 and/or partial face detector 504 of FIG. 5 may be implemented using a neural network 900.

An input layer 902 includes input data. Neural network 900 includes multiple hidden layers hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 900 is trained well enough so that the weights of the layers are accurately tuned.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

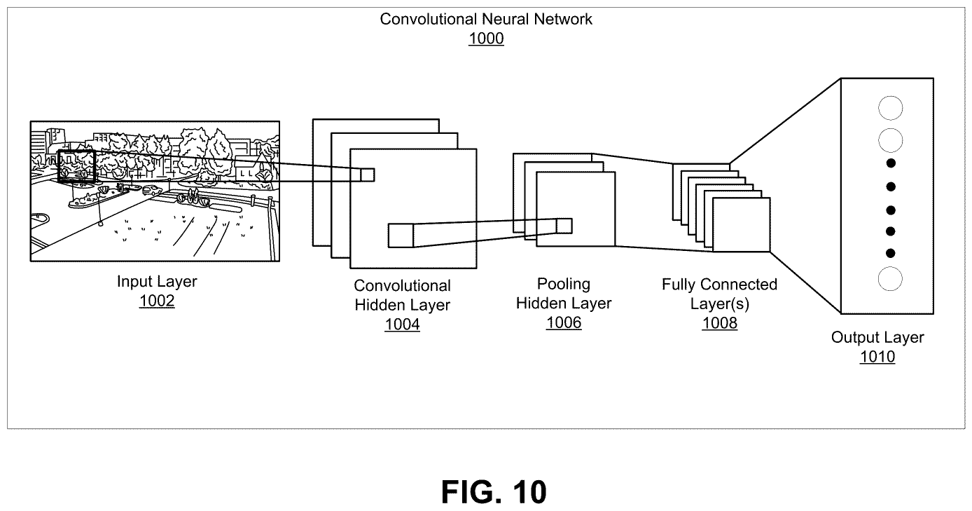

FIG. 10 is an illustrative example of a convolutional neural network (CNN) 1000. The input layer 1002 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1004, an optional non-linear activation layer, a pooling hidden layer 1006, and fully connected layer 1008 (which fully connected layer 1008 can be hidden) to get an output at the output layer 1010. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 can be the convolutional hidden layer 1004. The convolutional hidden layer 1004 can analyze image data of the input layer 1002. Each node of the convolutional hidden layer 1004 is connected to a region of nodes (pixels) of the input image called a receptive field. The convolutional hidden layer 1004 can be considered as one or more filters (each filter corresponding to a different activation or feature map), with each convolutional iteration of a filter being a node or neuron of the convolutional hidden layer 1004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1004. Each connection between a node and a receptive field for that node learns a weight and, in some cases, an overall bias such that each node learns to analyze its particular local receptive field in the input image. Each node of the convolutional hidden layer 1004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1004 is due to each node of the convolutional layer being applied to its corresponding receptive field. For example, a filter of the convolutional hidden layer 1004 can begin in the top-left corner of the input image array and can convolve around the input image. As noted above, each convolutional iteration of the filter can be considered a node or neuron of the convolutional hidden layer 1004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1004.

The mapping from the input layer to the convolutional hidden layer 1004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1004 can include several activation maps in order to identify multiple features in an image. The example shown in FIG. 10 includes three activation maps. Using three activation maps, the convolutional hidden layer 1004 can detect three different kinds of features, with each feature being detectable across the entire image.

In some examples, a non-linear hidden layer can be applied after the convolutional hidden layer 1004. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1000 without affecting the receptive fields of the convolutional hidden layer 1004.

The pooling hidden layer 1006 can be applied after the convolutional hidden layer 1004 (and after the non-linear hidden layer when used). The pooling hidden layer 1006 is used to simplify the information in the output from the convolutional hidden layer 1004. For example, the pooling hidden layer 1006 can take each activation map output from the convolutional hidden layer 1004 and generates a condensed activation map (or feature map) using a pooling function. Max-pooling is one example of a function performed by a pooling hidden layer. Other forms of pooling functions be used by the pooling hidden layer 1006, such as average pooling, L2-norm pooling, or other suitable pooling functions. A pooling function (e.g., a max-pooling filter, an L2-norm filter, or other suitable pooling filter) is applied to each activation map included in the convolutional hidden layer 1004. In the example shown in FIG. 10, three pooling filters are used for the three activation maps in the convolutional hidden layer 1004.

In some examples, max-pooling can be used by applying a max-pooling filter (e.g., having a size of 2×2) with a stride (e.g., equal to a dimension of the filter, such as a stride of 2) to an activation map output from the convolutional hidden layer 1004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1004 having a dimension of 24×24 nodes, the output from the pooling hidden layer 1006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1006 to every one of the output nodes in the output layer 1010. Using the example above, the input layer includes 28×28 nodes encoding the pixel intensities of the input image, the convolutional hidden layer 1004 includes 3×24×24 hidden feature nodes based on application of a 5×5 local receptive field (for the filters) to three activation maps, and the pooling hidden layer 1006 includes a layer of 3×12×12 hidden feature nodes based on application of max-pooling filter to 2×2 regions across each of the three feature maps. Extending this example, the output layer 1010 can include ten output nodes. In such an example, every node of the 3×12×12 pooling hidden layer 1006 is connected to every node of the output layer 1010.

The fully connected layer 1008 can obtain the output of the previous pooling hidden layer 1006 (which should represent the activation maps of high-level features) and determines the features that most correlate to a particular class. For example, the fully connected layer 1008 can determine the high-level features that most strongly correlate to a particular class and can include weights (nodes) for the high-level features. A product can be computed between the weights of the fully connected layer 1008 and the pooling hidden layer 1006 to obtain probabilities for the different classes. For example, if the CNN 1000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1010 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

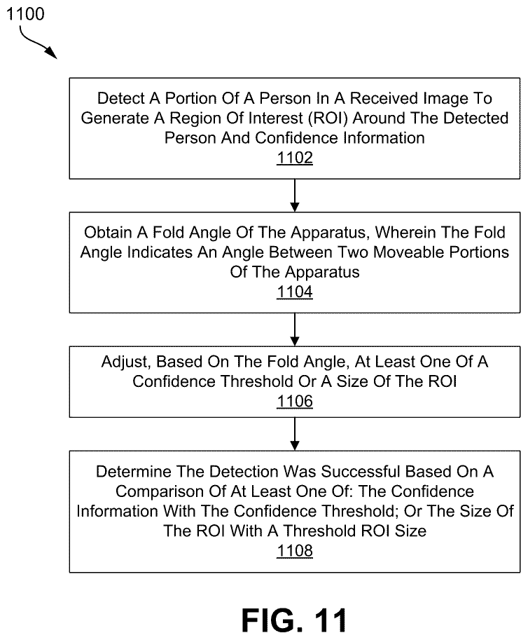

FIG. 11 is a flow diagram illustrating a process 1100 for presence detection, in accordance with aspects of the present disclosure. The process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors.

At block 1102, the computing device (or component thereof) may detect a portion of a person in an image to generate a region of interest (ROI) around the detected portion of the person and confidence information. In some cases, the portion of the person comprises a portion of a face of the person. For example, a face detector (e.g., full face detector) may detect a face and provide ROI information for the face. In some examples, the computing device (or component thereof) may detect the portion of the person in the image after attempting to detect a full face in the image has failed to detect the full face of the person. In some cases, the computing device (or component thereof) may include a screen. In some examples, the computing device (or component thereof) may activate the screen based on the determination that the detection was successful.

At block 1104, the computing device (or component thereof) may obtain a fold angle (e.g., fold angles 510 of FIG. 5) of the apparatus. In some cases, the fold angle indicates an angle between two moveable portions of the apparatus.

At block 1106, the computing device (or component thereof) may adjust, based on the fold angle, at least one of a confidence threshold (e.g., based on the high confidence threshold region 602 of FIG. 6, medium confidence threshold region 604 of FIG. 6, low confidence threshold region 606 of FIG. 6, etc.) or a size of the ROI. For example, the amount the ROI size may be increased or decreased may be based on the specific obtained fold angle. In some cases, the confidence threshold is adjusted by raising or reducing the confidence threshold. In some examples, the confidence threshold is set based on a location of the ROI in the image. In some cases, the confidence threshold varies for different regions of the image. In some examples, the confidence threshold is adjusted by adjusting a size or location of the regions of the image. In some cases, the computing device (or component thereof) may to adjust the size of the ROI by enlarging the ROI based on a determination that the fold angle is greater than a threshold fold angle. In some cases, the computing device (or component thereof) may to adjust the size of the ROI by reducing the size of the ROI based on a determination that the fold angle is less than a threshold fold angle. In some examples, the fold angle is obtained from a fold sensor of the apparatus. In some cases, the fold angle is obtained based on the image. In some cases, the computing device (or component thereof) may determine the fold angle based on a ratio between distances of facial landmarks in the image (e.g., tip of the nose, point between the eyes, center of the mouth, etc.).

At block 1108, the computing device (or component thereof) may determine the detection of the portion of the person was successful based on a comparison of at least one of the confidence information with the confidence threshold or the size of the ROI with a threshold ROI size.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1100 and/or other processes described herein may include a processor, microprocessor, micro-computer, or other component of a device that is configured to carry out the steps of the process 1100 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1100 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1100 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1100 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some examples, computing system 1200 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, camera, accelerometers, gyroscopes, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some examples, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:
Aspect 1. An apparatus for presence detection, comprising: at least one memory; and at least one processor coupled to the at least one memory and configured to: detect a portion of a person in an image to generate a region of interest (ROI) around the detected portion of the person and confidence information; obtain a fold angle of the apparatus, wherein the fold angle indicates an angle between two moveable portions of the apparatus; adjust, based on the fold angle, at least one of a confidence threshold or a size of the ROI; and determine the detection of the portion of the person was successful based on a comparison of at least one of the confidence information with the confidence threshold or the size of the ROI with a threshold ROI size.
Aspect 2. The apparatus of Aspect 1, wherein the portion of the person comprises a portion of a face of the person.
Aspect 3. The apparatus of any of Aspects 1-2, wherein the confidence threshold is adjusted by raising or reducing the confidence threshold.
Aspect 4. The apparatus of any of Aspects 1-3, wherein the confidence threshold is set based on a location of the ROI in the image.
Aspect 5. The apparatus of Aspect 4, wherein the confidence threshold varies for different regions of the image, and wherein the confidence threshold is adjusted by adjusting a size or location of the regions of the image.
Aspect 6. The apparatus of any of Aspects 1-5, wherein, to adjust the size of the ROI, the at least one processor is configured to enlarge the ROI based on a determination that the fold angle is greater than a threshold fold angle.
Aspect 7. The apparatus of any of Aspects 1-6, wherein, to adjust the size of the ROI, the at least one processor is configured to reduce the size of the ROI based on a determination that the fold angle is less than a threshold fold angle.
Aspect 8. The apparatus of any of Aspects 1-7, wherein the fold angle is obtained from a fold sensor of the apparatus.
Aspect 9. The apparatus of any of Aspects 1-8, wherein the fold angle is obtained based on the image.
Aspect 10. The apparatus of Aspect 9, wherein the at least one processor is configured to determine the fold angle based on a ratio between distances of facial landmarks in the image.
Aspect 11. The apparatus of any of Aspects 1-10, wherein detecting the portion of the person in the image is performed after attempting to detect a full face in the image has failed to detect the full face of the person.
Aspect 12. The apparatus of any of Aspects 1-11, wherein the apparatus includes a screen, and wherein the at least one processor is configured to activate the screen based on the determination that the detection was successful.
Aspect 13. A method for presence detection, comprising: detecting a portion of a person in an image to generate a region of interest (ROI) around the detected portion of the person and confidence information; obtaining a fold angle of a device, wherein the fold angle indicates an angle between two moveable portions of the device; adjusting, based on the fold angle, at least one of a confidence threshold or a size of the ROI; and determining the detection of the portion of the person was successful based on a comparison of at least one of the confidence information with the confidence threshold or the size of the ROI with a threshold ROI size.
Aspect 14. The method of Aspect 13, wherein the portion of the person comprises a portion of a face of the person.
Aspect 15. The method of any of Aspects 13-14, wherein the confidence threshold is adjusted by raising or reducing the confidence threshold.
Aspect 16. The method of any of Aspects 13-15, wherein the confidence threshold is set based on a location of the ROI in the image.
Aspect 17. The method of Aspect 16, wherein the confidence threshold varies for different regions of the image, and wherein the confidence threshold is adjusted by adjusting a size or location of the regions of the image.
Aspect 18. The method of any of Aspects 13-17, wherein adjusting the size of the ROI comprises enlarging the ROI based on a determination that the fold angle is greater than a threshold fold angle.
Aspect 19. The method of any of Aspects 13-18, wherein adjusting the size of the ROI comprises reducing the size of the ROI based on a determination that the fold angle is less than a threshold fold angle.
Aspect 20. The method of any of Aspects 13-19, wherein the fold angle is obtained from a fold sensor.
Aspect 21. The method of any of Aspects 13-20, wherein the fold angle is obtained based on the image.
Aspect 22. The method of Aspect 21, further comprising determining the fold angle based on a ratio between distances of facial landmarks in the image.
Aspect 23. The method of any of Aspects 13-22, wherein detecting the portion of the person in the image is performed after attempting to detect a full face in the image has failed to detect the full face of the person.
Aspect 24. The method of any of Aspects 13-23, wherein the device includes a screen, and further comprising activating the screen based on the determination that the detection was successful.
Aspect 25. A non-transitory computer-readable medium having stored thereon instructions that, when executed by at least one processor, cause the at least one processor to perform one or more operations according to any of Aspects 13-24.
Aspect 34: An apparatus for presence detection, comprising means for performing one or more of operations according to any of Aspects 13 to 24.

What is claimed is:

1. An apparatus for presence detection, comprising:
at least one memory; and
at least one processor coupled to the at least one memory and configured to:
detect a portion of a person in an image to generate a region of interest (ROI) around the detected portion of the person and confidence information;
obtain a fold angle of the apparatus, wherein the fold angle indicates an angle between two moveable portions of the apparatus;
adjust, based on the fold angle, at least one of a confidence threshold or a size of the ROI; and
determine the detection of the portion of the person was successful based on a comparison of at least one of the confidence information with the confidence threshold or the size of the ROI with a threshold ROI size.

2. The apparatus of claim 1, wherein the portion of the person comprises a portion of a face of the person.

3. The apparatus of claim 1, wherein the confidence threshold is adjusted by raising or reducing the confidence threshold.

4. The apparatus of claim 1, wherein the confidence threshold is set based on a location of the ROI in the image.

5. The apparatus of claim 4, wherein the confidence threshold varies for different regions of the image, and wherein the confidence threshold is adjusted by adjusting a size or location of the regions of the image.

6. The apparatus of claim 1, wherein, to adjust the size of the ROI, the at least one processor is configured to enlarge the ROI based on a determination that the fold angle is greater than a threshold fold angle.

7. The apparatus of claim 1, wherein, to adjust the size of the ROI, the at least one processor is configured to reduce the size of the ROI based on a determination that the fold angle is less than a threshold fold angle.

8. The apparatus of claim 1, wherein the fold angle is obtained from a fold sensor of the apparatus.

9. The apparatus of claim 1, wherein the fold angle is obtained based on the image.

10. The apparatus of claim 9, wherein the at least one processor is configured to determine the fold angle based on a ratio between distances of facial landmarks in the image.

11. The apparatus of claim 1, wherein detecting the portion of the person in the image is performed after attempting to detect a full face in the image has failed to detect the full face of the person.

12. The apparatus of claim 1, wherein the apparatus includes a screen, and wherein the at least one processor is configured to activate the screen based on the determination that the detection was successful.

13. A method for presence detection, comprising:
detecting a portion of a person in an image to generate a region of interest (ROI) around the detected portion of the person and confidence information;
obtaining a fold angle of a device, wherein the fold angle indicates an angle between two moveable portions of the device;
adjusting, based on the fold angle, at least one of a confidence threshold or a size of the ROI; and
determining the detection of the portion of the person was successful based on a comparison of at least one of the confidence information with the confidence threshold or the size of the ROI with a threshold ROI size.

14. The method of claim 13, wherein the portion of the person comprises a portion of a face of the person.

15. The method of claim 13, wherein the confidence threshold is adjusted by raising or reducing the confidence threshold.

16. The method of claim 13, wherein the confidence threshold is set based on a location of the ROI in the image.

17. The method of claim 16, wherein the confidence threshold varies for different regions of the image, and wherein the confidence threshold is adjusted by adjusting a size or location of the regions of the image.

18. The method of claim 13, wherein adjusting the size of the ROI comprises enlarging the ROI based on a determination that the fold angle is greater than a threshold fold angle.

19. The method of claim 13, wherein adjusting the size of the ROI comprises reducing the size of the ROI based on a determination that the fold angle is less than a threshold fold angle.

20. The method of claim 13, wherein the fold angle is obtained from a fold sensor.
